(19) United States
(12) Patent Application Publication
(10) Pub. No.: US 2009/0038749 A1
(43) Pub. Date: Feb. 12, 2009

(54) ADHESIVE FILM AND METHOD OF FABRICATING FLEXIBLE DISPLAY USING THE SAME

(75) Inventors: Gi-Heon Kim, Daejeon (KR); Yong-Hae Kim, Gyeonggi-do (KR); Chul-Am Kim, Seoul (KR); Kyung-Soo Suh, Daejeon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 12/119,020

(22) Filed: May 12, 2008

(30) Foreign Application Priority Data
Aug. 6, 2007 (KR) 10-2007-0078449

(51) Int. Cl. B32B 38/10; B32B 7/12

(52) U.S. Cl. 156/247; 428/354

(57) ABSTRACT

Provided is an adhesive film used for manufacturing a flexible display. The adhesive film includes a support body, a first adhesive layer, and a second adhesive layer. The support body has a first surface and a second surface. A flexible substrate is attached on the first surface. A support substrate is attached on the second surface. The second surface is opposite to the first surface. The first adhesive layer is provided on the first surface of the support body, and the second adhesive layer is provided on the second surface of the support body. The first adhesive layer and the second adhesive layer have the same adhesive strength.

### CROSS-REFERENCE TO RELATED APPLICATIONS

This U.S. non-provisional patent application claims priority under 35 U.S.C. §119 of Korean Patent Application No. 10-2007-78449, filed on Aug. 6, 2007, the entire contents of which are hereby incorporated by reference.

### BACKGROUND OF THE INVENTION

The present invention disclosed herein relates to a method of fabricating a display having flexibility, and more particularly, to an adhesive film that can easily separate a flexible substrate from a support substrate preventing warping of the flexible substrate, and a method of fabricating a flexible display using the adhesive film.

The present invention has been derived from research conducted as a part of IT R & D program of Ministry of Information and Communication and Institution of Information Technology Association (MIC/IITA) [2005-S-070-03], flexible display.

As a modern industrial society develops into a high level information-oriented age, importance of a display industry visualizing various information from various devices and delivering the information to a human being increases. It is expected that this trend will continue in the future for a considerable period. As advancement, generalization, and popularization of information-orientation progress, a human being's desire for information has increased. Accordingly, researches for expressing colors close to nature and elaborateness close to nature to meet a visual sense of a human being without limitations in place and time are under active progress in the field of a display, which is a man-machine interface of information.

Generally, a display is widely used for televisions, monitors, and mobile phones. However, as technology develops, a display that is lightweight, has a large display area, has an excellent resolution, and has a fast response time is required.

To meet these requirements, efforts for manufacturing a large-sized display, and reducing the density and thickness of a substrate forming the display are under active progress. However, as such efforts cause lots of limitations in aspects of stability and reliability of a manufacturing process of a display device, they face technical limit.

Also, reduction in the size of the display device to make portability easy has a limitation in that the reduction is contradictory to a consumer's desire demanding a display device having a large-sized screen. Therefore, a demand for a flexible display where the wirings and elements of the display device are formed on a flexible substrate increases to simultaneously meet characteristics such as flexibility, lightweightness, and portability, increases.

In case of a flexible substrate, an existing semiconductor and display mass production equipment cannot be directly used because the flexible substrate is warped during a manufacturing process of a flexible display. Accordingly, the equipment for a flexible substrate only should be developed, or the existing mass production equipment should be remarkably changed. Existing display manufacturing companies have designed a chuck exclusively used for a flexible substrate and applied the chuck to an existing mass production equipment to realize a flexible display. However, these applications have a limitation that it is difficult to secure stability and reliability during a manufacturing process of the flexible display.

### SUMMARY OF THE INVENTION

The present invention provides an adhesive film that allows a flexible substrate to be easily separated from a support substrate used for preventing warping of the flexible substrate during a manufacturing process of a flexible display that uses an existing semiconductor and display mass production equipment.

The present invention also provides a method of manufacturing a flexible display that allows a flexible substrate to be easily separated from a support substrate used for preventing warping of the flexible substrate during a manufacturing process of a flexible display that uses an existing semiconductor and display mass production equipment.

Embodiments of the present invention provide adhesive films used for manufacturing a flexible display, the adhesive films including: a support body having a first surface on which a flexible substrate is attached, and a second surface on which a support substrate is attached, the second surface being opposite to the first surface; a first adhesive layer provided on the first surface of the support body; and a second adhesive layer provided on the second surface of the support body, the first adhesive layer and the second adhesive layer having the same adhesive strength.

In some embodiments, the support body includes at least one of polyethylene terephthalate, polybutylene terephthalate, polyimide, polyester, and polyolefin.

In other embodiments, the flexible substrate includes at least one of a metal foil, a thin glass substrate, and a plastic substrate.

In still other embodiments, the support substrate is a glass substrate or a silicon substrate.

In even other embodiments, each of the first adhesive layer and the second adhesive layer has adhesive strength in a range of 0.2-60 N/100 mm.

In yet other embodiments, each of the first adhesive layer and the second adhesive layer includes at least one of an acrylate-based adhesive material, a silicon-based adhesive material, and an epoxy-based adhesive material.

In other embodiments of the present invention, methods for manufacturing a flexible display include: preparing an adhesive film including a support body having a first surface on which a flexible substrate is attached, and a second surface on which a support substrate is attached, the second surface being opposite to the first surface, a first adhesive layer provided on the first surface of the support body, and a second adhesive layer provided on the second surface of the support body; attaching the support substrate onto the second surface of the support body; attaching the flexible substrate onto the first surface of the support body; forming a driving device and a display element on a surface of the flexible substrate that faces the first surface of the support body; and separating the flexible substrate from the support substrate, the first adhesive layer and the second adhesive layer having the same adhesive strength.

In some embodiments, the support body includes at least one of polyethylene terephthalate, polybutylene terephthalate, polyimide, polyester, and polyolefin.

In other embodiments, the flexible substrate includes at least one of a metal foil, a thin glass substrate, and a plastic substrate.

In still other embodiments, the support substrate is a glass substrate or a silicon substrate.

In even other embodiments, each of the first adhesive layer and the second adhesive layer has adhesive strength in a range of 0.2-60 N/100 mm.

In yet other embodiments, each of the first adhesive layer and the second adhesive layer includes at least one of an acrylate-based adhesive material, a silicon-based adhesive material, and an epoxy-based adhesive material.

In further embodiments, the driving device includes a thin film transistor (TFT). The TFT includes at least one of an organic TFT, an amorphous TFT, and a polycrystal TFT.

In still further embodiments, the flexible substrate is defined as a TFT substrate by the forming of the driving device.

In even further embodiments, the display element includes at least one of a liquid crystal, an organic light emitting diode, and electronic paper.

In yet further embodiments, the display element includes a color pixel layer. The flexible substrate is defined as a color filter substrate by the forming of the display element.

In still further embodiments, the separating of the flexible substrate from the support substrate includes irradiating an ultraviolet (UV) ray.

In still further embodiments, the separating of the flexible substrate from the support substrate includes: preparing a chemical bath in which a chemical solvent is provided; and dipping an adhesive structure where the driving device and the display element have been formed in the chemical solvent.

In still further embodiments, the chemical solvent is an organic solvent.

In still further embodiments, the organic solvent includes at least one of chemical solutions having benzene, toluene, xylene, acetone, and an aldehyde group.

In still other embodiments of the present invention, methods of manufacturing a flexible display include: preparing an adhesive film including a support body having a first surface on which a flexible substrate is attached, and a second surface on which a support substrate is attached, the second surface being opposite to the first surface, a first adhesive layer provided on the first surface of the support body, and a second adhesive layer provided on the second surface of the support body; attaching the support substrate onto the second surface of the support body; attaching the flexible substrate onto the first surface of the support body; forming a driving device and a display element on a surface of the flexible substrate that faces the first surface of the support body; and simultaneously reducing adhesive strengths of the first and second adhesive layers to separate the flexible substrate from the support substrate.

In some embodiments, the simultaneously reducing of the adhesive strengths of the first and second adhesive layers includes irradiating an ultraviolet (UV) ray.

In other embodiments, the simultaneously reducing of the adhesive strengths of the first and second adhesive layers includes using a chemical solvent.

In still other embodiments, the using of the chemical solvent includes preparing a chemical bath in which the chemical solvent is provided; and dipping an adhesive structure where the driving device and the display element have been formed in the chemical solvent.

As described above, according to the present invention, warping of the flexible substrate is minimized, so that the flexible display can be manufactured without change of the existing semiconductor and display mass production equipment.

Also, according to the present invention, stability in the manufacturing process of the flexible display is secured, and the flexible display of high stability and reliability can be provided.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a cross-sectional view explaining an adhesive structure in a manufacturing process of a flexible display according to an embodiment of the present invention;

FIG. 2 is a cross-sectional view explaining an adhesive film used for a manufacturing process of a flexible display according to an embodiment of the present invention;

FIGS. 3A and 3B are cross-sectional views explaining a method of manufacturing a flexible display according to an embodiment of the present invention; and

FIGS. 4A through 4C are cross-sectional views explaining a method of manufacturing a flexible display according to another embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Also, since reference numerals are used for the preferred embodiments, reference numerals provided according to the order of the explanation are not necessarily limited to that order.

In the figures, the dimensions of layers and regions are exaggerated for clarity of illustration. It will also be understood that when a layer (or film) is referred to as being ‘on’ another layer or substrate, it can be directly on the other layer or substrate, or intervening layers may also be present.

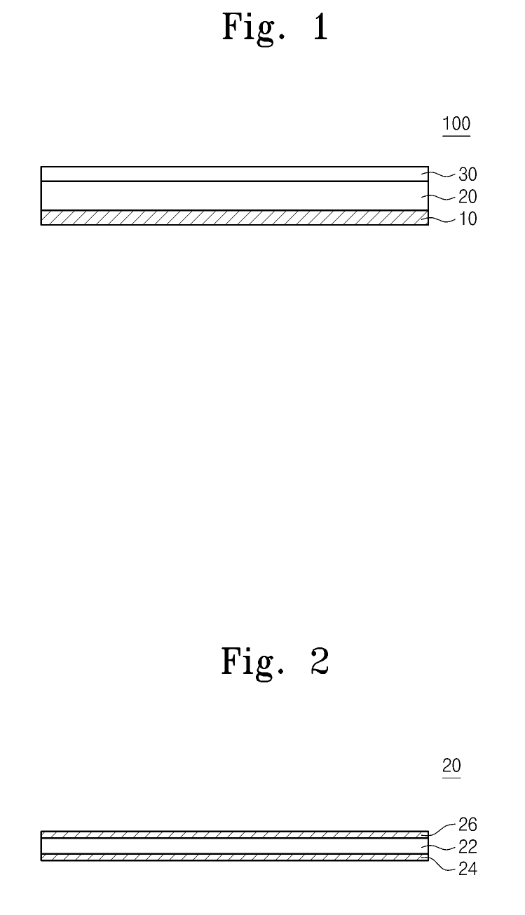

FIG. 1 is a cross-sectional view explaining an adhesive structure in a manufacturing process of a flexible display according to an embodiment of the present invention.

Referring to FIG. 1, an adhesive structure 100 in the manufacturing process of the flexible display may include a support substrate 10, an adhesive film 20, and a flexible substrate 30.

The support substrate 10 may serve as a fixing plate for preventing warping of the flexible substrate 30 during a manufacturing process of the flexible display. The support substrate 10 may be a glass substrate or a silicon substrate.

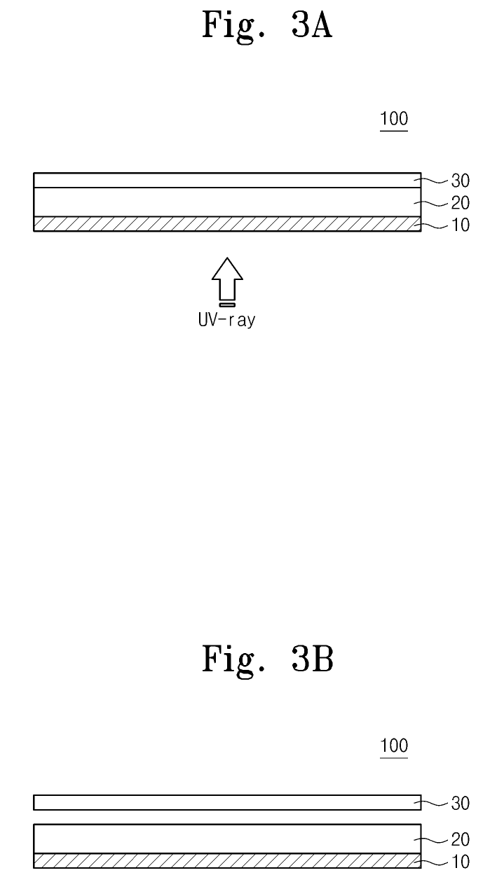

The adhesive film 20 may fix the flexible substrate 30 onto the support substrate 10 during the manufacturing process of the flexible display. Also, the adhesive film 20 may cancel stress generated by a difference in a coefficient of thermal expansion (CTE) between the flexible substrate 30 and the support substrate 10 during the manufacturing process of the flexible display. Accordingly, the warping of the flexible substrate 30 may be minimized during the manufacturing process of the flexible display. Both sides of the adhesive film 20 may have adhesiveness to closely attach the support substrate 10 and the flexible substrate 30 to each other. The adhesive film 20 according to an embodiment of the present invention is described in detail with reference to FIG. 2.

The flexible substrate 30 may be formed as a flexible display through the manufacturing process of the flexible display. A driving device (not shown) and a display element (not shown) may be formed on the surface of the flexible substrate 30 facing the interface between the adhesive film 20 and the flexible substrate 30 through the manufacturing process of the flexible display. The flexible substrate 30 may include at least one of a metal foil, a thin glass substrate (having a thickness of 0.3 mm or less), and a plastic substrate.

FIG. 2 is a cross-sectional view explaining an adhesive film according to an embodiment of the present invention.

Referring to FIG. 2, the adhesive film 20 may include a support body 22, a first adhesive layer 26, and a second adhesive layer 24.

The support body 22 may have a first surface on which the flexible substrate 30 is attached, and a second surface on which the support substrate 10 is attached. The second surface is opposite to the first surface. The support body 22 may serve as a core material on which the first adhesive layer 26 and the second adhesive layer 24 of the adhesive film 20 are coated. The support body 22 may include at least one of polyethylene terephthalate, polybutylene terephthalate, polyimide, polyester, and polyolefin. The polyolefin may include one of polyethylene, polypropylene, and polyisobutylene. The support body 22 may be formed of polyimide because the polyimide has characteristics of excellent heat proof and chemical durability.

The first adhesive layer 26 may be coated on the first surface of the support body 22 so that the flexible substrate may be attached on the first surface. The first adhesive layer 26 can have adhesive strength in the range of 0.2-60 N/100 mm. The first adhesive layer 26 may include at least one of an acrylate-based adhesive material, a silicon-based adhesive material, and an epoxy-based adhesive material. The first adhesive layer 26 may be the silicon-based adhesive material.

The second adhesive layer 24 may be coated on the second surface of the support body 22 so that the support substrate may be attached on the second surface. Like the first adhesive layer 26, the second adhesive layer 24 can have adhesive strength in the range of 0.2-60 N/100 mm. The second adhesive layer 24 may include at least one of an acrylate-based adhesive material, a silicon-based adhesive material, and an epoxy-based adhesive material. The second adhesive layer 24 may be the silicon-based adhesive material.

In the adhesive film according to the embodiment of the present invention, the first and second adhesive layers 26 and 24 have the substantially same adhesive strength in the range of 0.2-60 N/100 mm. This configuration may be for chemically and simultaneously separating the first adhesive layer and the second adhesive layer attaching on the flexible substrate and the support substrate, respectively. The fact that the adhesive strengths of the first and second adhesive layers are the substantially same may mean that a difference in the adhesive strength between the first and second adhesive layers is in such a trivial error range as to be ignored.

When the adhesive strengths of the first and second adhesive layers are less than 0.2 N/100 mm, the flexible substrate and the first adhesive layer and/or the support substrate and the second adhesive layer may be easily separated from each other by stress applied during the manufacturing process of the flexible display. Also, when the adhesive strengths of the first and second adhesive layers exceeds 60 N/100 mm, the devices formed on the flexible substrate may be damaged physically and/or chemically during a process of separating the flexible substrate from the support substrate.

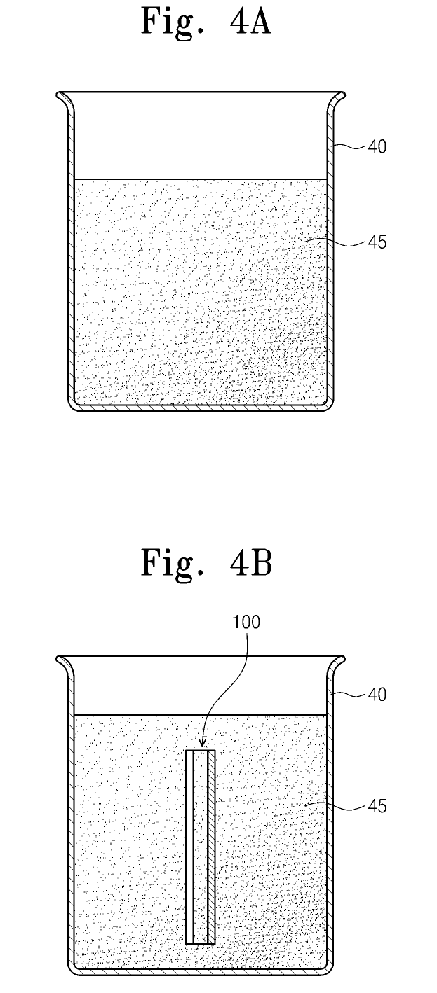

FIGS. 3A and 3B are cross-sectional views explaining a method of manufacturing a flexible display according to an embodiment of the present invention.

Referring to FIG. 3A, the adhesive film 20 including the support body 20 (of FIG. 2) having the first surface on which the flexible substrate 30 may be attached, and the second surface on which the support substrate 10 may be attached, the second surface being opposite to the first surface, the first adhesive layer 26 (of FIG. 2) provided on the first surface of the support body, and the second adhesive layer 24 (of FIG. 2) provided on the second surface of the support body 20, is prepared. The first adhesive layer and the second adhesive layer may have the same adhesive strength.

The support substrate 10 may be attached on the second surface of the support body with the second adhesive layer interposed. The flexible substrate 30 may be attached on the first surface of the support body with the first adhesive layer interposed. Accordingly, an adhesive structure 100 including the support substrate 10, the adhesive film 20, and the flexible substrate 30 may be formed.

A driving device (not shown) and a display element (not shown) may be formed on a surface of the flexible substrate 30 facing the first surface of the support body. Accordingly, the adhesive structure 100 where the driving device and the display element have been formed may be formed.

The driving device may include a thin film transistor (TFT). The TFT may include at least one of an organic TFT, an amorphous TFT, and a polycrystal TFT. The flexible substrate 30 may be defined as a TFT substrate by forming a TFT, which is a driving device.

The display element may include at least one of a liquid crystal display (LCD), an organic light emitting diode (OLED), and electronic (e)-paper. Also, the display element may include a color pixel layer. The flexible substrate 30 may be defined as a color filter substrate by forming the color pixel layer, which is a display element.

The flexible substrate 30 may be separated from the support substrate 10. The separating the flexible substrate 30 from the support substrate 10 may be performed by irradiating an ultraviolet (UV) ray. The adhesive strengths of the first adhesive layer and the second adhesive layer included in the adhesive film 20 attaching the flexible substrate 30 and the support substrate 10 to each other may be reduced due to a chemical reaction by the UV ray irradiated to the first and second adhesive layers. Accordingly, the flexible substrate 30 may be easily separated from the support substrate 10.

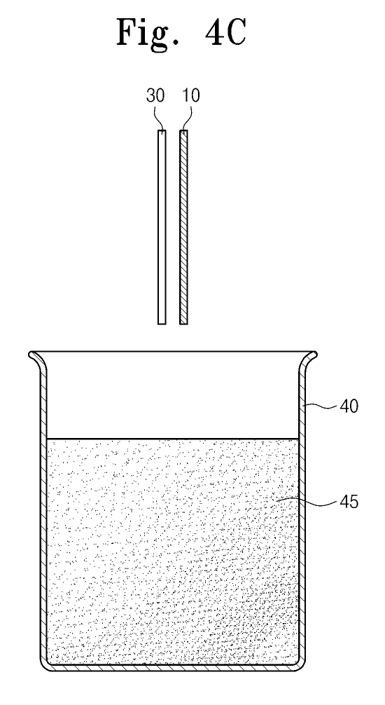

FIGS. 4A through 4C are cross-sectional views explaining a method of manufacturing a flexible display according to another embodiment of the present invention.

Referring to FIG. 4A, a chemical bath 40 in which a chemical solvent 45 is provided may be prepared. The chemical solvent may be an organic solvent. The organic solvent may include at least one of chemical solutions having benzene, toluene, xylene, acetone, and an aldehyde group (—CHO).

Referring to FIGS. 4B and 4C, an adhesive structure 100 where the driving device and the display element described in FIG. 3A have been formed may be dipped in the chemical solvent 45 provided to the chemical bath 40. As the adhesive film 20 (of FIG. 1) closely attaching the flexible substrate 30 and the support substrate 20 to each other may be removed by a chemical reaction with the chemical solvent 45, the adhesive strength of the adhesive film may be reduced. Also, as the first adhesive layer 26 (of FIG. 2) and the second adhesive layer 24 (of FIG. 2) included in the adhesive film may be removed by a chemical reaction with the chemical solvent 45, the adhesive strengths of the first and second adhesive layers may be reduced. Accordingly, the flexible substrate 30 may be easily separated from the support substrate 10.

The warping of the flexible substrate may be minimized by manufacturing the flexible display using the adhesive film according to the embodiment of the present invention. Accordingly, the flexible display may be manufactured without change of the existing semiconductor and display mass production equipment. Also, since the flexible substrate is chemically separated from the support substrate used for preventing the warping of the flexible substrate, the stability in the manufacturing process of the flexible display may be secured. Therefore, the flexible display having high stability and reliability may be provided.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An adhesive film used for manufacturing a flexible display, the adhesive film comprising:
a support body having a first surface on which a flexible substrate is attached, and a second surface on which a support substrate is attached, the second surface being opposite to the first surface;
a first adhesive layer provided on the first surface of the support body; and
a second adhesive layer provided on the second surface of the support body,
wherein the first adhesive layer and the second adhesive layer having the same adhesive strength.

2. The adhesive film of claim 1, wherein each of the first adhesive layer and the second adhesive layer has adhesive strength in a range of 0.2-60 N/100 mm.

3. The adhesive film of claim 2, wherein each of the first adhesive layer and the second adhesive layer comprises at least one of an acrylate-based adhesive material, a silicon-based adhesive material, and an epoxy-based adhesive material.

4. A method for manufacturing a flexible display, the method comprising:
preparing an adhesive film comprising a support body having a first surface on which a flexible substrate is attached, and a second surface on which a support substrate is attached, the second surface being opposite to the first surface, a first adhesive layer provided on the first surface of the support body, and a second adhesive layer provided on the second surface of the support body;
attaching the support substrate onto the second surface of the support body;
attaching the flexible substrate onto the first surface of the support body;
forming a driving device and a display element on a surface of the flexible substrate that faces the first surface of the support body; and
separating the flexible substrate from the support substrate,
wherein the first adhesive layer and the second adhesive layer having the same adhesive strength.

5. The method of claim 4, wherein each of the first adhesive layer and the second adhesive layer has adhesive strength in a range of 0.2-60 N/100 mm.

6. The method of claim 5, wherein each of the first adhesive layer and the second adhesive layer comprises at least one of an acrylate-based adhesive material, a silicon-based adhesive material, and an epoxy-based adhesive material.

7. The method of claim 4, wherein the flexible substrate is defined as a TFT substrate by the forming of the driving device.

8. The method of claim 4, wherein the display element comprises a color pixel layer.

9. The method of claim 8, wherein the flexible substrate is defined as a color filter substrate by the forming of the display element.

10. The method of claim 4, wherein the separating of the flexible substrate from the support substrate comprises irradiating an ultraviolet (UV) ray.

11. The method of claim 4, wherein the separating of the flexible substrate from the support substrate comprises:
preparing a chemical bath in which a chemical solvent is provided; and
dipping an adhesive structure where the driving device and the display element have been formed in the chemical solvent.

12. The method of claim 11, wherein the chemical solvent comprises an organic solvent.

13. The method of claim 12, wherein the organic solvent comprises at least one of chemical solutions having benzene, toluene, xylene, acetone, and an aldehyde group.

14. A method of manufacturing a flexible display, the method comprising:
preparing an adhesive film including a support body having a first surface on which a flexible substrate is attached, and a second surface on which a support substrate is attached, the second surface being opposite to the first surface, a first adhesive layer provided on the first surface of the support body, and a second adhesive layer provided on the second surface of the support body;
attaching the support substrate onto the second surface of the support body;
attaching the flexible substrate onto the first side of the support body;
forming a driving device and a display element on a surface of the flexible substrate that faces the first surface of the support body; and
simultaneously reducing adhesive strengths of the first and second adhesive layers to separate the flexible substrate from the support substrate.

15. The method of claim 14, wherein the simultaneously reducing of the adhesive strengths of the first and second adhesive layers comprises irradiating an ultraviolet (UV) ray.

16. The method of claim 14, wherein the simultaneously reducing of the adhesive strengths of the first and second adhesive layers comprises using a chemical solvent.

17. The method of claim 16, wherein the using of the chemical solvent comprises:
preparing a chemical bath in which the chemical solvent is provided; and
dipping an adhesive structure where the driving device and the display element have been formed in the chemical solvent.
